(19) United States
(12) Patent Application Publication
(10) Pub. No.: US 2008/0052153 A1
(43) Pub. Date: Feb. 28, 2008

(54) Method and apparatus for facilitating targeted advertising

(76) Inventor: Scott D. Cook, Mountain View, CA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/508,603

(22) Filed: Aug. 22, 2006

(51) Int. Cl. G06Q 30/00

(52) U.S. Cl. 705/14

(57) ABSTRACT

One embodiment of the present invention provides a system that performs targeted advertising based on expenditure-related information from a financial application. During operation, the system first obtains the expenditure-related information from the financial application. Next, the system uses the expenditure-related information to select one or more advertisements to display to a user of the financial application, and then displays the one or more selected advertisements to the user.

### BACKGROUND

The present invention generally relates to computer-based systems that facilitate advertising.

Advertising has played a key role in revolutionizing business. Some of the most revolutionary changes have been accomplished when advertisers pay businesses to publish their advertisements, thereby allowing businesses to steeply discount products to consumers. For example, the development of the modern newspaper in the 1800's can largely be attributed to revenue from advertising, which allowed news to be printed and distributed at a low price to consumers. Similarly, in the 1920's, advertising-supported broadcasting rapidly created a giant industry that provided free entertainment.

Although advertising is largely responsible for the success of the newspaper and broadcasting industries, advertisers who use these types of media have a difficult time targeting advertisements to specific consumers who are interested in purchasing their products. Most viewers of these advertising messages have little or no interest in purchasing the advertised products.

Advertisers have tried to achieve more focused advertising through direct mail. It is expensive, however, to obtain mailing lists that effectively target a desired group of consumers. It is also expensive to pay for the printing and postage associated with direct mail. Furthermore, consumers are typically bombarded with so much direct mail that they largely ignore it.

The dramatic financial success of search engine providers, such as Google™, can largely be attributed to the ability of search engines to facilitate focused advertising. When a user enters a search string into a search engine, words in the search string are likely to reflect the intent of the user. For example, if a user performs a search involving the word “Tuscany” the user is likely to be planning a trip to Tuscany. Hence, it makes sense to provide the user with ads that link to web sites for travel services.

Search engine providers, such as Google™, have been able to monetize this focused advertising by allowing advertisers to bid on micro-targeted adwords. When an advertiser successfully bids for an adword, links to the advertiser's website will be displayed whenever a user enters the adword in a search string. This type of targeted advertising has proven to be extremely effective for advertisers and at the same time extremely lucrative for search engine providers. It also provides a great value for consumers by delivering a continuous stream of relevant product advances to consumers for free.

A computer user, however, typically spends a significant amount of time using applications other than search engines. While using these other applications, the user continues to enter data and perform actions that reflect the user's intent. For example, a user who writes a large check to a title company and records the check in an accounting application is likely to be purchasing a property. At present, these non-search engine applications have not exploited such user-related information to perform targeted advertising.

Note that privacy concerns may significantly impede the adoption of a system that performs targeted advertising based on such user-related information. There has recently been a public outcry about applications, such as spyware, which examine a user's data or behavior and report this information to a server. Hence, it is important to be sensitive to these privacy concerns while designing a system that performs targeted advertising based on such user-related information.

### SUMMARY

One embodiment of the present invention provides a system that performs targeted advertising based on expenditure-related information from a financial application. During operation, the system first obtains the expenditure-related information from the financial application. Next, the system uses the expenditure-related information to select one or more advertisements to display to a user of the financial application, and then displays the one or more selected advertisements to the user.

In a variation on this embodiment, the system additionally receives payment from advertisers for displaying the selected advertisements to the user, or for responses by the user to the selected advertisements.

In a variation on this embodiment, the system additionally stages an auction between multiple advertisers for the right to display selected advertisements based on expenditure-related information.

In a variation on this embodiment, the financial application can be sold to the user at a discounted price based on the fact that advertising will be displayed to the user.

In a variation on this embodiment, the expenditure-related information can include, but is not limited to: information specifying categories for expenditures; names of vendors associated with expenditures; amounts of expenditures; changes in spending behavior; vendor location information; a buyer's bill-to or ship-to address(s); or revenue levels, revenue sources and revenue changes for an entity associated with the expenditure-related information.

In a variation on this embodiment, the expenditure-related information can additionally include, but is not limited to: bank account information, credit card account information, PayPal™ account information, and other account-related information transmitted from a financial institution or found on a website belonging to the financial institution.

In a variation on this embodiment, the expenditure-related information can additionally include, but is not limited to: purchase records for the user or other records on the user's behavior found on third-party websites, such as Amazon™ or eBay™, or found in applications, such as Internet Explorer™ or Firefox™.

In a variation on this embodiment, displaying the selected advertisements to the user can involve, but is not limited to: displaying the selected advertisements through the financial application; displaying the selected advertisements through a browser; displaying the selected advertisements through a pop-up; sending direct mail (or email) to the user; or placing a telephone call to the user.

In a variation on this embodiment, selecting the advertisements can involve considering, but is not limited to considering: information from a questionnaire filled out by the user; browsing behavior of the user; non-expenditure-related information obtained from the financial application; and information from other applications accessed by the user, such as an email application, a word-processing application, or a desktop search application.

In a variation on this embodiment, selecting the advertisements can involve considering, but is not limited to considering, whether the expenditure-related information indicates: the user has purchased from a competitor of an advertiser; the user has not made a specific type of expenditure and hence is part of a “virgin market” for the specific type of expenditure; the user has recently moved; the user has recently had or will soon have a new baby; the user has recently hired a new employee; an organization associated with the user is growing; the user recently made a new investment; the user recently retired; the user got a new job; or the dollar amount purchased by the user of a category or a product.

In a variation on this embodiment, displaying the selected advertisements to the user involves presenting the user with a promotional discount.

In a further variation, a large promotional discount is presented to a user who is a high-expenditure customer of a competitor.

In a variation on this embodiment, displaying the advertisements to the user involves allowing the user to invite multiple vendors to submit competitive bids to win the user's business.

In a variation on this embodiment, the financial application is an online application, wherein the advertisements are selected by a remote server which has access to the expenditure-related information.

In a variation on this embodiment, the financial application executes on a local machine and selects the advertisements from a larger set of advertisements provided by a remote server.

In a variation on this embodiment, the financial application is an accounting application.

Note that some embodiments of the present invention report user-related information to an advertising server, which (as mentioned above) may trigger privacy concerns. To address these privacy concerns, one embodiment of the present invention performs the ad-selection operations entirely on the user's computer system instead of on a remote server. In this way, the user's expenditure-related and other personal information, which is used during the ad-selection process, can be kept private within the user's computer system and never needs to be communicated to a server.

In a variation on this embodiment, clicks on ad links are tracked to facilitate billing the advertisers.

### BRIEF DESCRIPTION OF THE FIGURES

FIG. 1 illustrates a system that facilitates targeted advertising in accordance with an embodiment of the present invention.

FIG. 2 illustrates another system that facilitates targeted advertising in accordance with another embodiment of the present invention.

FIG. 3 presents a flow chart illustrating the process of facilitating an auction for advertisers who desire to display ads in accordance with an embodiment of the present invention.

FIG. 4 presents a flow chart illustrating the process of selecting and displaying ads in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

### Overview

One embodiment of the present invention uses expenditure-related information obtained from a financial application, such as an accounting program, to select advertisements to be displayed to a user of the financial application. This general technique provides a number of compelling advantages.

By examining expenditure-related information, advertisers can target just those people who are actually involved in the buying process. Furthermore, it enables advertisers to target customers of a competitor or prospects who are considering a competitor.

The technique also enables marketers to tailor their advertising message to a prospect based on information about the prospect obtained from the financial application. For example, a business whose accounting records indicate that they are a large business might be presented with a better offer than a business whose accounting records indicate that they are a small business. Or, a high-volume consumer of a product or a service might be presented with a better offer than a low-volume consumer.

This selective targeting of advertisements can be highly effective. For example, consider a tax-preparation application. Targeted advertising that makes use of data from this type of application could for example target: (1) taxpayers who just discovered how big their refund will be; (2) investors who invest in particular funds, fund companies, or brokers at the one time of the year when all investors are examining the income they received from their current fund company or broker; (3) taxpayers looking for more deductions at the very time they are looking for more deductions; (4) taxpayers paying taxable interest and dividends who are in tax brackets where tax-free investments deliver higher returns.

Furthermore, the above-described advertisement-targeting technique is virtually free of cost because leads are collected with no media cost, no mailing cost, no printing costs, and no costs from reaching those not in the actual buying process.

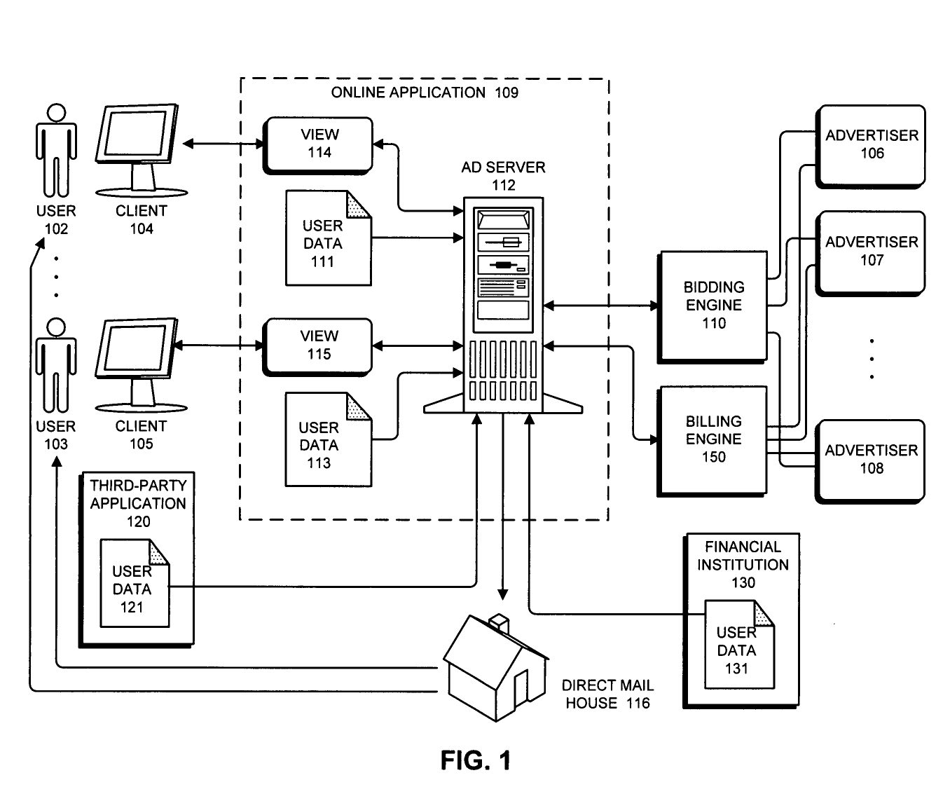

Variations of the present invention are described in more detail below with reference to FIGS. 1-4.

### Online System

FIG. 1 illustrates an online version of a system that facilitates targeted advertising in accordance with an embodiment of the present invention. This system includes an online application 109, which is hosted by a server and which communicates with users 102 and 103 who are operating client machines 104 and 105, respectively.

Online application 109 can generally include any type of computer-based application which is accessed by a user. In one embodiment of the present invention, online application 109 is an accounting application, such as: QuickBooks™ distributed by Intuit, Inc. of Mountain View, Calif.; Peachtree Quantum Accounting™, distributed by Sage Software of Pleasanton, Calif.; or Denali Premium Accounting Software Suite™, distributed by Cougar Mountain Software of Boise, Id. In general, online application 109 can include any type of application which maintains user-related or expenditure-related information which can be used for purposes of targeted advertising.

Online application 109 maintains data for each user. More specifically, online application 109 maintains user-data 111 for user 102, and similarly maintains user-data 113 for user 103.

Online application 109 also generates a customized view 114 for user 103 as well as a customized view 115 for user 103. These customized views can include advertisements, which are provided by ad server 1112, to be displayed to users 102 and 103. More specifically, ad server 112 inserts ads into customized view 114 for user 102 based on information contained within user-data 111 for user 102. Similarly, ad server 112 inserts ads into customized view 115 for user 103 based on information contained within user-data 113 for user 103.

Note that the user-related data which is used to select ads can also be obtained from other sources. For example, referring to FIG. 1, user data 121 can be obtained from a third-party application 120 or a third-party web site. Furthermore, other types of user data 131, such as account information, can be obtained from a financial institution 130 or may be found on a website belonging to a financial institution 130.

In one embodiment of the present invention, the user data can be obtained through an “obtaining mechanism,” which can generally include any type of mechanism that can obtain data from an application. For example, the obtaining mechanism can include code (or firmware) that reads user data from online application 109, or code (or firmware) that interacts through a network with a third-party application 120, a third-party web site, or a financial institution 130.

Furthermore, in one embodiment of the present invention, after the user data is obtained, ads can be selected by a “selection mechanism,” which can generally include any type of mechanism that can select an ad based on expenditure-related information or other user-related information. For example, this selection mechanism can be structured as a lookup table, a database system or any type of mapping mechanism that maps information to ads.

In a variation on this embodiment, the expenditure-related information can additionally include: bank account information, credit card account information, PayPal™ account information, investment information, and other account-related information transmitted from a financial institution or found on a website belonging to the financial institution.

Note that instead of (or in addition to) inserting advertisements into the views, ad server 112 can contact a direct mail house 116 to send direct mail (or email) to users 102 and 103.

In one embodiment of the present invention, the ads can be displayed through a “display mechanism,” which can generally include any type of mechanism that can display an advertisement. For example, this display mechanism can include a computer display, a printer or a web browser.

As is illustrated in FIG. 1, in some embodiments a number of advertisers 106-108 communicate with a bidding engine 110, which facilitates an auction between advertisers 106-108. During this auction, the advertisers can bid to display targeted ads to users who are selected based on characteristics of their user-data.

After the targeted ads are selected and are displayed to a user, a billing engine 150 can bill advertisers 106-108 for displaying the selected ads to the user, or for responses by the user to the selected ads.

### Desk-Top System

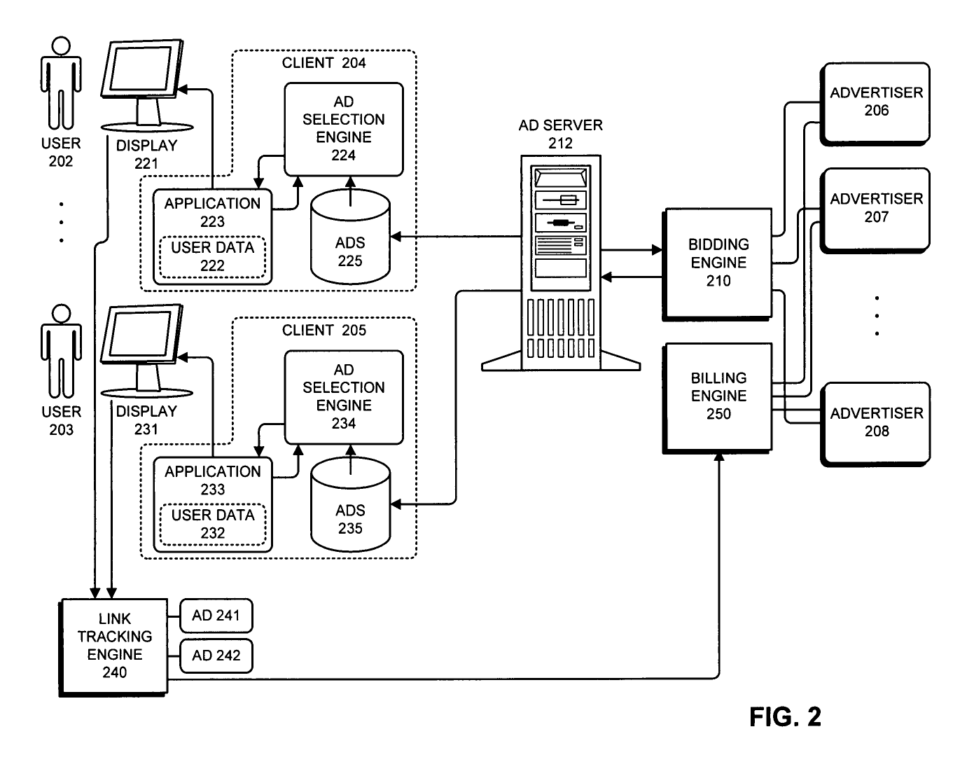

FIG. 2 illustrates another embodiment of the present invention, wherein the application which is accessed by the user (e.g., a financial application) is not located on a server, but is instead located on a computing system operated by the user. In this embodiment, a separate instance of this application is installed on each client system. For example, in FIG. 2, application instance 223 resides on client machine 204, and application instance 233 resides on client machine 205.

These application instances 223 and 233 maintain user-data locally on the client machines. More specifically, application instance 223 maintains user-data 222 associated with user 202 on client machine 204, and application instance 233 maintains user-data 232 associated with user 203 on client machine 205.

Client machines 204 and 205 also maintain a local collection of ads as well as local ad-selection engines. More specifically, client machine 204 maintains a local collection of ads 225 and a local ad-selection engine 224. Similarly, client machine 205 maintains a local collection of ads 235 and a local ad-selection engine 234. These local ad-selection engines 224 and 234 operate by selecting ads to be displayed to users 202 and 203 based on user-data 222 and 232, respectively.

In some embodiments, the system illustrated in FIG. 2 also includes a bidding engine 210, which facilitates a bidding process between advertisers 206-208. Bidding engine 210 communicates with ad server 212. However, ad server 212 does not actually select specific ads to be displayed to specific users. Instead, ad server 212 sends a large collection of ads to client machines 204 and 205 to be stored in their local collections of ads 225 and 235, respectively. As was described above, the selection process is then performed locally by ad-selection engines 224 and 234.

The desktop version of the system is attractive for users who do not want to store confidential user-data on a remote server which is controlled by a third party. However, in order for the advertisers to be billed, some amount of information needs to be communicated from the client systems to a billing engine 250. FIG. 2 illustrates a link tracking engine 240, which tracks ads that users click on. This user-click information is sent to billing engine 250, which bills advertisers 206-207 based on which ads the users click on. Note that ad server 212 is bypassed entirely during this billing process. Furthermore, because the user's confidential data never leaves the user's machine, this system protects the privacy of the user's confidential information (except for information which can be inferred from the ads that the user clicks on).

In either the online version or the desktop version, the users may want an assurance from the application provider that user-data will remain confidential, and will only be used for billing purposes.

### Bidding Process

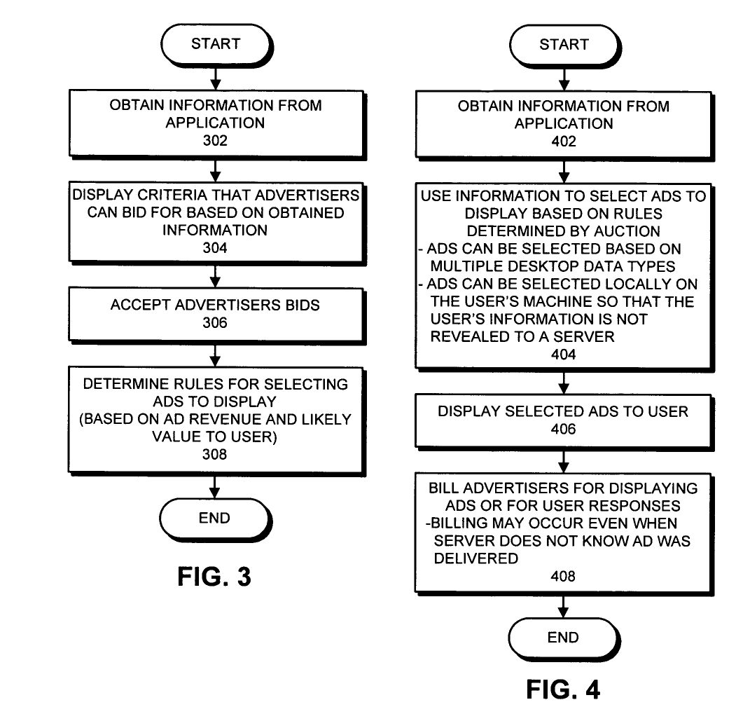

FIG. 3 presents a flow chart illustrating the process of facilitating an auction for advertisers in accordance with an embodiment of the present invention. The process starts by obtaining user-data from an application. For example, this can involve obtaining expense-related information from an accounting application (step 302). Next, the system compiles information obtained from the user-data, and then displays various criteria that advertisers can bid for (step 304). For example, advertisers can bid to display adds to users who have recently incurred moving-related expenses.

Next, the system accepts bids from advertisers (step 306). The system then uses these bids to determine a set of rules for selecting advertisements to display to users (step 308). These rules can be structured in a number of ways. For example, the rules can be structured to maximize revenue obtained from the advertisers. However, they can also be structured to optimize value provided to the user. Note that providing value to users will make users more likely to view the advertisements, which will provide an incentive for users to opt-in to viewing the advertisements.

### Ad-Selection Process

FIG. 4 presents a flow chart illustrating the process of selecting and displaying ads in accordance with an embodiment of the present invention. First, the system obtains information from the application (step 402). As mentioned above, this information can include any type of user-related information.

Next, the system uses the obtained information to select ads to display (step 404). These ads are selected based on the rules, which were previously determined from advertiser's bids. For example, the ads can be selected based on multiple desktop data types.

Note that this selection process can take place at a server for the online version of the application, or alternatively, can take place on the client machine, for the desktop version of the application. Note that if the selection process takes place on the client machine, the user's information never needs to be revealed to a server.

This selection process can involve considering any type of user-data which is maintained by the application. This can include, but is not limited to: expenditure-related information obtained from the application; other non-expenditure-related information obtained from the application; information from a questionnaire filled out by the user; or browsing behavior of the user.

The questionnaire data can be obtained by asking users about their business and about their business-related expenses. For example, the users can be asked: what categories of merchandise they buy; how much they buy; who they buy from; and what business purchases or decisions they have recently made.

Ads can also be selected based on the user's behavior outside of the application. For example, a user who recently visited web pages for Xerox copiers might receive ads from Canon's copier division.

In another example, suppose a user visits the Acura website, which suggests the user is interested in higher-end import cars. Later on, suppose the user reads a story on a new site about Iraq's latest suicide bombings. Rather than displaying some commercially-irrelevant, low-value ad, to the user, the news site can display an ad from Lexus. Because Lexus and Acura are competitors, Lexus may be willing the pay a relatively large sum for an ad which directly targets Acura customers.

Next, after the ads have been selected, the system displays the ads to the user (step 406). These advertisements can be displayed to the user in a number of ways. For example, the system can: display the selected advertisements through the financial application; display the selected advertisements through a browser; display the selected advertisements through a pop-up; send direct mail or email to the user; or can place a telephone call to the user.

Note that a given advertisement can present the user with a promotional discount to help win the user's business. For example, a large promotional discount can be presented to a user who is a high-expenditure customer of a competitor of the advertiser.

In a variation on the present invention, while displaying the ads to the user, the system enables the user to invite multiple vendors to submit competitive bids to win the user's business. For example, the user could fill out a short questionnaire which describes the user's situation. This information would enable the vendors to return some type of bid for the user's business. The system could then auction the right to respond to the user to a fixed number of vendors.

Finally, the system bills the advertisers (step 408). Note that the advertisers can be billed in a number of ways. For example, they can be billed simply for having their ads displayed to users, or they can be billed based on a user response, for example, such as click-throughs. Note that if the billing process takes place through the link tracing engine 240 and through billing engine 250 which are illustrated in FIG. 2, the billing process circumvents ad server 212. In this case, ad server 212 does not even have to know that the ad was delivered.

### Opting-In

One embodiment of the present allows users of an application to “opt-in” to receive advertisements in exchange for a discounted price for the application. This can be accomplished by providing two editions of the application: (1) a normal edition without advertisements which is provided to the user at a normal price, and (2) a discounted or free edition, which includes ads.

These editions would have the same features. The difference between the additions is that users of the alternative edition know they will be marketed to in strictly defined and controlled ways. The amount of marketing would be strictly limited in quantity, and in the ways the users' data can be used, to make the marketing more relevant to the user.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for performing targeted advertising based on expenditure-related information from a financial application, comprising:
obtaining the expenditure-related information from the financial application;
using the expenditure-related information to select one or more advertisements to display to a user of the financial application; and
displaying the one or more selected advertisements to the user.

2. The method of claim 1, further comprising receiving payment from one or more advertisers for displaying the selected advertisements to the user, or for responses by the user to the selected advertisements.

3. The method of claim 2, wherein the method further comprises staging an auction between multiple advertisers for the right to display selected advertisements based on expenditure-related information.

4. The method of claim 1, wherein the method further comprises selling the financial application to the user at a discounted price based on the fact that advertising will be displayed to the user.

5. The method of claim 1, wherein the expenditure-related information includes, but is not limited to, one or more of the following:
information specifying categories for expenditures;
names of vendors associated with expenditures;
amounts of expenditures;
changes in spending behavior;
vendor location information;
a buyer's bill-to or ship-to address(s); and
revenue levels, revenue sources and revenue changes for an entity associated with the expenditure-related information.

6. The method of claim 1, wherein the expenditure-related information can additionally include, but is not limited to: bank account information, credit card account information, PAYPAL™ account information, and other account-related information transmitted from a financial institution or found on a website belonging to the financial institution.

7. The method of claim 1, the expenditure-related information can additionally include, but is not limited to, purchase records for the user or other records on the user's behavior found on third-party websites, or found in applications accessed by the user.

8. The method of claim 1, wherein displaying the selected advertisements to the user can involve, but is limited to, one or more of the following:
displaying the selected advertisements through the financial application;
displaying the selected advertisements through a browser;
displaying the selected advertisements through a pop-up;
sending direct mail (or email) to the user; or
placing a telephone call to the user.

9. The method of claim 1, wherein selecting the advertisements additionally involves considering, but is not limited to considering, one or more of the following:
information from a questionnaire filled out by the user;
browsing behavior of the user;
non-expenditure-related information obtained from the financial application; and
information from other applications accessed by the user.

10. The method of claim 1, wherein selecting the advertisements can involve considering, but is not limited to considering, whether the expenditure-related information indicates:
the user has purchased from a competitor of an advertiser;
the user has not made a specific type of expenditure and hence is part of a “virgin market” for the specific type of expenditure;
the user has recently moved;
the user has recently had or will soon have a new baby;
the user has recently hired a new employee;
an organization associated with the user is growing;
the user recently made a new investment;
the user recently retired;
the user got a new job; or
the dollar amount purchased by the user of a category or a product.

11. The method of claim 1, wherein displaying the selected advertisements to the user involves presenting the user with a promotional discount.

12. The method of claim 9, wherein a large promotional discount is presented to a user who is a high-expenditure customer of a competitor.

13. The method of claim 1, wherein displaying the advertisements to the user involves allowing the user to invite multiple vendors to submit competitive bids to win the user's business.

14. The method of claim 1, wherein the financial application is an online application, wherein the advertisements are selected by a remote server which has access to the expenditure-related information.

15. The method of claim 1, wherein the financial application executes on a local machine and selects the advertisements from a larger set of advertisements provided by a remote server.

16. The method of claim 1, wherein the financial application is an accounting application.

17. The method of claim 1, wherein the task of selecting the one or more advertisements is performed entirely on the user's computer system, so that the user's expenditure-related and other personal information is not known outside of the user's computer system.

18. A computer-readable storage medium storing instructions that when executed by a computer cause the computer to perform a method for performing targeted advertising based on expenditure-related information from a financial application, the method comprising:
obtaining the expenditure-related information from the financial application;
using the expenditure-related information to select one or more advertisements to display to a user of the financial application; and
displaying the one or more selected advertisements to the user.

19. The computer-readable storage medium of claim 18, wherein the method further comprises receiving payment from one or more advertisers for displaying the selected advertisements to the user, or for responses by the user to the selected advertisements.

20. The computer-readable storage medium of claim 19, wherein the method further comprises staging an auction between multiple advertisers for the right to display selected advertisements based on expenditure-related information.

21. The computer-readable storage medium of claim 18, wherein the method further comprises selling the financial application to the user at a discounted price based on the fact that advertising will be displayed to the user.

22. The computer-readable storage medium of claim 18, wherein the expenditure-related information includes, but is not limited to, one or more of the following:
information specifying categories for expenditures;
names of vendors associated with expenditures;
amounts of expenditures;
changes in spending behavior;
vendor location information;
a buyer's bill-to or ship-to address(s); and
revenue levels, revenue sources and revenue changes for an entity associated with the expenditure-related information.

23. The computer-readable storage medium of claim 18, wherein the expenditure-related information can additionally include, but is not limited to:
bank account information, credit card account information, PAYPAL™ account information, and other account-related information transmitted from a financial institution or found on a website belonging to the financial institution.

24. The computer-readable storage medium of claim 18, wherein the expenditure-related information can additionally include, but is not limited to, purchase records for the user or other records on the user's behavior found on third-party websites, or found in applications accessed by the user.

25. The computer-readable storage medium of claim 18, wherein displaying the selected advertisements to the user can involve, but is not limited to, one or more of the following:
displaying the selected advertisements through the financial application;
displaying the selected advertisements through a browser;
displaying the selected advertisements through a pop-up;
sending direct mail (or email) to the user; or
placing a telephone call to the user.

26. The computer-readable storage medium of claim 18, wherein selecting the advertisements can additionally involve considering, but is not limited to considering, one or more of the following:
information from a questionnaire filled out by the user;
browsing behavior of the user;
non-expenditure-related information obtained from the financial application; and
information from other applications accessed by the user.

27. The computer-readable storage medium of claim 18, wherein selecting the advertisements can involve considering, but is not limited to considering, whether the expenditure-related information indicates the user has purchased from a competitor of an advertiser;
the user has not made a specific type of expenditure and hence is part of a “virgin market” for the specific type of expenditure;
the user has recently moved;
the user has recently had or will soon have a new baby;
the user has recently hired a new employee;
an organization associated with the user is growing;
the user recently made a new investment;
the user recently retired;
the user got a new job; or
the dollar amount purchased by the user of a category or a product.

28. The computer-readable storage medium of claim 18, wherein displaying the selected advertisements to the user involves presenting the user with a promotional discount.

29. The computer-readable storage medium of claim 28, wherein a large promotional discount is presented to a user who is a high-expenditure customer of a competitor.

30. The computer-readable storage medium of claim 18, wherein displaying the advertisements to the user involves allowing the user to invite multiple vendors to submit competitive bids to win the user's business.

31. The computer-readable storage medium of claim 18, wherein the financial application is an online application, wherein the advertisements are selected by a remote server which has access to the expenditure-related information.

32. The computer-readable storage medium of claim 18, wherein the financial application executes on a local machine and selects the advertisements from a larger set of advertisements provided by a remote server.

33. The computer-readable storage medium of claim 18, wherein the financial application is an accounting application.

34. The computer-readable storage medium of claim 18, wherein the task of selecting the one or more advertisements is performed entirely on the user's computer system, so that the user's expenditure-related and other personal information is not known outside of the user's computer system.

35. An apparatus that performs targeted advertising based on expenditure-related information from a financial application, comprising:
an obtaining mechanism configured to obtain the expenditure-related information from the financial application;
a selection mechanism configured to use the expenditure-related information to select one or more advertisements to display to a user of the financial application; and
a display mechanism configured to display the one or more selected advertisements to the user.
